(19) United States
(12) Patent Application Publication
(10) Pub. No.: US 2011/0021734 A1
(43) Pub. Date: Jan. 27, 2011

(54) STARCH HYBRID POLYMERS

(75) Inventors: Gamini S. Samaranayake, Broadview Heights, OH (US); Richard F. Tomko, North Olmsted, OH (US); Philip J. Ruhoff, Shaker Heights, OH (US); Madhukar Rao, Twinsburg, OH (US)

Correspondence Address: Deron A. Cook, Esq.;The Sherwin-Williams Company - Legal Dept., 101 W. Prospect Avenue, Cleveland, OH, 44115, US

(73) Assignee: THE SHERWIN-WILLIAMS COMPANY, Cleveland, OH (US)

(21) Appl. No.: 12/835,800

(22) Filed: Jul. 14, 2010

Related U.S. Application Data
(60) Provisional application No. 61/225,301, filed on Jul. 14, 2009.

(51) Int. Cl. C08F 251/02

(52) U.S. Cl. 527/314; 527/313

(57) ABSTRACT

Film forming polymers derived substantially from biorenewable polysaccharides may be formed as the emulsion polymerization products of a blend of hydrophobic polysaccharides and ethylenically unsaturated monomers. The hydrophobic polysaccharides may be prepared as the emulsion reaction product of a water soluble polysaccharide and a monomer mixture of hydrophilic ethylenically unsaturated monomers and hydrophobic ethylenically unsaturated monomer, in the presence of a water soluble chain transfer agent.

### I. BACKGROUND OF THE INVENTION

The present invention is directed to polymeric resins and resin dispersions suitable for use in the formulation of coatings, sealants, caulks, and adhesives, wherein the resins are substantially derived from biorenewable polysaccharides.

There is considerable interest in formulating architectural paints and other coatings, sealants, adhesives, and caulks that incorporate significant levels of materials that are or are derived from renewable resources. The present invention is directed to film forming polymeric resins having particular, but not exclusive utility in formulations for aqueous architectural paints, which incorporate at least 15% by weight, and in other embodiments at least 20% by weight, and in some embodiments, up to about 25% by weight of biorenewable polysaccharides. The present invention also describes one and two-stage polymerization methods for preparing film forming polymeric resins and emulsions comprising such resins. Still further, the present invention describes coating formulations comprising the film-forming binders herein described.

### II. DETAILED DESCRIPTION OF THE INVENTION

The binders or resins of the present invention may be formed by the emulsion polymerization of a monomer mixture comprising (a) one or more low molecular weight polysaccharides, which in some embodiments may be hydrophobically modified, with (b) one or more conventional, ethylenically unsaturated monomers. Various emulsion polymerization processes, described in further detail below, may be employed to formulate the binders herein described.

In one such embodiment, a hydrophobically modified polysaccharide may be formed in situ as the reaction product of one or more water soluble polysaccharides and an ethylenically unsaturated monomer blend comprising hydrophilic and hydrophobic ethylenically unsaturated monomers, preferably in conjunction with a water soluble chain transfer agent. Suitable water soluble polysaccharides may have a solubility of greater than about 30 weight percent and may include low molecular weight unmodified starch or low molecular weight starch modified to enhance water solubility. Following in situ formation of the hydrophobically modified polysaccharide, further polymerization with conventional ethylenically unsaturated monomers may proceed in a second polymerization stage to generate resins having from 15% up to about 25% by weight derived from the initial polysaccharide feed stock and which demonstrate excellent stability and scrub resistance.

The low molecular weight polysaccharides of the present invention will most usefully have a number average molecular weight of between about 1000 and about 80000, and still more usefully, between about 1000 and about 60000. However, polysaccharides having molecular weights between about 1,000 and about 100,000, with polysaccharides having a molecular weight of between about 3,000 to about 80,000 may be useful in some embodiments. Low molecular weight polysaccharides, such as starch, having a molecular weight less than about 60,000, tend to be water soluble.

The term “polysaccharide” includes starch; namely amylose and amylopectin, and dextrins derived from the processing of starch, including maltodextrins and cyclodextrins. Polysaccharides may also include cellulosic materials such as microbial polysaccharides, and water soluble cellulose fragments generated by hydrolysis of fiber, and plant gums; hemicellulose, Guar gums and gum Arabic.

Starch is a particularly useful polysaccharide. Starch may be degraded into lower molecular weight dextrins enzymatically, by hydrolysis and/or by thermal degradation. Suitable starches may be obtained from many readily available and biorenewable sources, such as corn, wheat, potatoes, and rice; however it is not believed that the starch source is vital to the practice of this invention.

In some embodiments, it may be useful to employ a polysaccharide “derivative”. The term “polysaccharide derivative” refers to a polysaccharide that has been selectively modified by the addition of one or more functional groups or other moieties. Non-limiting examples of processes that may be used to create polysaccharide derivatives include oxidation, carboxylation, ethoxylation, propoxylation, alkylation and alkanoylation. Depending on the type of chemistry these modifications may be classified as hydrophobic or hydrophilic.

The embodiments of the invention employ a hydrophobically modified polysaccharide, which may be “pre-made” or generated in situ, in the formation of graft-polymer resins. Using or, as described in further detail below, generating starch derivatives having hydrophobic characteristics in parity with that of hydrophobic ethylenically unsaturated monomers, which are to be reacted therewith, may yield emulsion polymerization reaction products, such as the resins of the present invention, having a high level of monomer grafting in the starch backbone yielding resins having from 15 to 30% by weight provided by the starch. The high level of polysaccharide incorporation into the polymer resin may be as a result of improved interaction of the polysaccharide derivative, which is or has been rendered more hydrophobic, with oleophilic monomers.

Accordingly, in some embodiments of the invention, it is useful to employ a pre-made hydrophobically modified polysaccharide. “Pre-made” simply refers to a polysaccharide derivative that is generated in a completely separate processing step from the emulsion polymerization employed to generate the polymer resins. Examples of available, pre-made hydrophobically modified polysaccharides include the hydroxyalkyl starches, such as hydroxypropyl starch. Hydroxypropyl starch may be prepared by the reaction of starch and propylene oxide. Useful, pre-made hydroxylpropyl starches are commercially available from Grain Processing Corporation. These materials may be procured in the form of an insoluble gel, which may be processed for further suitable use in accordance with the methods of this invention by jet cooking or wet milling the gel to less than 600 micron particle size.

Other useful hydrophobically modified starch derivatives may include octenyl maltodextrin. Still other useful hydrophobically modified polysaccharide derivatives may include polysaccharides modified with an activated vinylic functionality such as maleic, fumaric, acrylic, or methacrylic acids.

A useful film-forming binder may be formed by the emulsion polymerization reaction product of a mixture comprising one or a blend of hydrophobically modified polysaccharide derivatives and one or a blend of conventional ethylenically unsaturated monomers.

Suitable ethylenically unsaturated monomers may include vinyl monomers, acrylic monomers, allylic monomers, acrylamides, acrylonitriles N-vinyl amides, N-allyl amines and their quaternary salts and mono- and dicarboxylic unsaturated acids and vinyl ethers. Vinyl esters may be used and may include vinyl acetate, vinyl propionate, vinyl butyrates, vinyl neodeconate and similar vinyl esters; vinyl halides include vinyl chloride, vinyl fluoride and vinylidene chloride; vinyl aromatic hydrocarbons include styrene, a-methyl styrene, and similar lower alkyl styrenes. Acrylic monomers may include monomers such as acrylic or methacrylic acid esters of aliphatic alcohols having 1 to 18 carbon atoms as well as aromatic derivatives of acrylic and methacrylic acid. Useful acrylic monomers may include, for example,; methyl acrylate, and methacrylate, ethyl acrylate and methacrylate, butyl acrylate and methacrylate, propyl acrylate and methacrylate, 2-ethyl hexyl acrylate and methacrylate, cyclohexyl acrylate and methacrylate, decyl acrylate and methacrylate, isodecylacrylate and methacrylate, and benzyl acrylate and methacrylate; poly(propylene glycol) acrylates and methacrylates, poly(ethylene glycol) acrylates and methacrylates and their ethers of alcohols containing from 1 to 18 carbon atoms.

In some embodiments, described in further detail below, it is particularly useful that the monomer mixture comprise a blend of ethylenically unsaturated monomers in which at least a portion of the ethylenically unsaturated monomer blend comprises hydrophilic, namely, water soluble ethylenically unsaturated monomers. In some useful embodiments, the ethylenically unsaturated monomer blend may comprise at least 5% hydrophilic monomers and in others, at least 10%.

For purposes hereof, hydrophilic, ethylenically unsaturated monomers are those having combined oxygen and nitrogen content greater than 30% by weight. Non-limiting examples of suitable hydrophilic ethylenically unsaturated monomers may include vinyl acetate, acrylic acid, methacrylic acid, hydroxyethyl methacrylate, hydroxypropyl methacrylate, acrylamide and methacrylamide, hydroxyethyl acrylate, N-methylacrylamide, N-hydroxymethyl acrylate and methacrylate, dimethylaminoethyl methacrylate, methacryloxyethyl trimethyl ammonium chloride or other monomers that give a water soluble polymer directly or by suitable post reaction. Especially suitable are poly(propylene glycol) acrylates and methacrylates, poly(ethylene glycol) acrylates and methacrylates and their ethers of methyl or ethyl alcohol.

Hydrophobic, ethylenically unsaturated monomers include those having an oxygen and nitrogen content less than 30% by weight. Non-limiting examples of suitable hydrophobic ethylenically unsaturated monomers may include, methyl methacrylate, methyl acrylate, styrene, alpha-methylstyrene, butyl acrylate, butyl methacrylate, amyl methacrylate, hexyl methacrylate, lauryl methacrylate, stearyl methacrylate, ethylhexyl methacrylate, crotyl methacrylate, cinnamyl methacrylate, oleyl methacrylate, ricinoleyl methacrylate, vinyl butyrate, vinyl tert-butyrate, vinyl stearate, vinyl laurate, vinyl versitate or other monomers that give a water insoluble polymer.

In one embodiment of the invention, a polymeric binder may be formed as a one-stage emulsion polymerization reaction product of a monomer mixture comprising:
A) from about 5 to about 60% by weight with respect to total monomer mixture of a hydrophobically modified polysaccharide derivative or blend thereof; and
B) from about 40 to about 95% by weight with respect to total monomer mixture of an ethylenically unsaturated monomer or blend thereof.

In a particularly useful embodiment, the hydrophobically modified polysaccharide may be alkyl, hydroxyalkyl, or alkanoyl derivatives of low molecular weight starch, such as starch octenyl succinate. The molecular weight of the hydrophobically modified polysaccharide derivative may be between about 3000 and about 80000.

One or more surfactants/emulsifying agents may be used in the emulsion polymerization. Suitable such agents may include any that are generally used in emulsion polymerization, including, without limitation, anionic surfactants such as alkali or ammonium salt of aliphatic acids, alkylsulfates and phosphates having a C₈-C₁₈ alkyl residue, alkyl polyether sulfates and phosphates having a C₈-C₁₈ alkyl residue and alkyl phenol ethoxylates of C₈-C₁₂ alkyl residues sodium dodecylbenzenesulfonate; cationic surfactants such as cetyltrimethylammonium bromide, and dodecylamine chloride; nonionic surfactants such as alkylphenyl polyethers having a C₈-C₁₂ alkyl residue, and and alkyl polyether having a C₈-C₁₈ alkyl residues, and the like. These agents may be used singly or two or more of them may be used in combination. Surfactants may be used in amounts ranging from about 0.5% to about 20% with respect to total monomer weight.

A free radical initiator may be used. The free radical initiator may be any of those conventionally used in emulsion polymerization processes, including, without limitation persulfates or organic peroxides such as potassium persulfate, and ammonium persulfate, cumene hydroperioxide, benzoyl peroixde; redox initiators such as those comprising a persulfate or organic peroxide with a reducing agent such as ferrous sulfate, and sodium sulfite, and the like. The initiator may be used in amounts ranging from about 0.01% to about 6% with respect to total monomer weight.

Other additives that may be useful in the emulsion polymerization include flocculating agents, defoamers, wetting agents crosslinking agents such as diacetone acrylamide (DAAM), acetylacetoxyethylmethacrylate (AAEM), and hydroxymethyl acrylamide. Particularly useful are light-curing crosslinking agents, such as benzophenones, benzothizoles. Camphor quinone and fulvenes modified resins. The agents may be used in amounts of about 3 to about 6% with respect to total monomer weight.

The just described embodiment may be referred to herein as a one-stage emulsion polymerization to distinguish it from the two-stage emulsion polymerization process described in further detail below. The one-stage emulsion polymerization uses as a starting material in the monomer mixture, a hydrophobically modified polysaccharide derivative, such as an alkyl, hydroxyalkyl, or alkanoyl starch derivative. In the two-stage process described below, it is permissible that the polysaccharide starting material be hydrophobically modified, but it is necessary that the polysaccharide is water soluble, being at least 30 weight percent soluble. The material may be an unmodified low molecular weight polysaccharide, or a derivative thereof that has been modified to increase water solubility, which is hydrophobically modified in situ during stage one of the polymerization, with subsequent polymer growth occurring in a second polymerization stage.

The polymer resulting from the one-stage emulsion polymerization will preferably have from about 5 to about 60% by weight (with respect to total polymer weight) derived from the hydrophobically modified starch starting material, and in some embodiments, greater than about 15% by weight of the polymer reaction product will be contributed by the polysaccharide, and in still further embodiments, greater than 20% by weight.

The resultant polymer may have a glass transition temperature (Tg) of between about −20° C. and about 70° C. In some particularly useful embodiments, the polymer will have a Tg of about −16° C. to about 21° C.; however, the Tg may, in some embodiments be as high as 100° C. The particle size of the resultant polymer as measured by laser light scattering may be between about 200 and 250 nm and, in some embodiments, about 120 to about 600 nm.

According to another embodiment of the present invention, a resin having high levels of incorporated polysaccharide may be generated as the reaction product of a monomer mixture comprising a low molecular weight, water soluble starch that is hydrophobically modified in situ, thus allowing for the use of lower cost, unmodified starches, such as low molecular weight dextrin, as starting materials in place of the pre-made hydrophobically-modified starch derivatives used in the one-stage polymerization process discussed above.

A two-stage emulsion polymerization process may be employed, in which, during the first stage, hydrophobically modified starch derivatives are generated in situ as the emulsion polymerization reaction product of water soluble starch, such as a low molecular weight dextrin, and a blend of ethylenically unsaturated monomers, which may, in some embodiments, depending on the relative water solubility of the hydrophilic monomers used, comprise from about 1 to about 10% by weight hydrophilic, ethylenically unsaturated monomers, and in some embodiments, about 10% by weight hydrophilic ethylenically unsaturated monomers and in other embodiments, greater than 10% by weight up to about 50% by weight.

In this embodiment, polymerization commences in the water phase. In stage one, substantially all the starch may be charged to the reaction chamber containing water, with a blend of ethylenically unsaturated monomers, comprising from 1 to about 10% by weight of hydrophilic, ethylenically unsaturated monomers, to yield a monomer mixture in which approximately 60 to 95%, and preferably about 75 to 85% of the monomer mass is starch and the remaining 5 to 40%, and preferably 15 to 25% of the monomer mass is the blend of ethylenically unsaturated monomers.

A particularly useful blend of ethylenically unsaturated monomers, for at least stage one polymerization, may comprise at least 1% hydrophilic ethylenically unsaturated monomers. Particularly useful hydrophilic monomers of this type include poly(propyleneglycol)acrylates and methacrylates, poly(ethyleneglycol)acrylates and methacrylates, and their corresponding C₁ to C₂ alkyl ethers. In other embodiments, the mixture may comprise methyl methacrylate, butyl acrylate, 2-ethylhexyl acrylate and one or more vinyl alkanoates: such as vinyl acetate and vinyl versetate.

In a particularly useful embodiment of the present invention, the ethylenically unsaturated monomer mixture comprises vinyl acetate, which has sufficient water solubility to enter into a water-phase free radical grafting reaction that transforms starch molecules into hydrophobic nucleating sites. Vinyl acetate also has a high chain transfer activity so that the use of an additional water soluble chain transfer agent is unnecessary.

The polymerization reaction may be initiated by addition of a suitable water-soluble initiator. One or more surfactants and free radical initiators, such as those described previously, may be used in stage one polymerization. The entire mixture may be blended at an elevated temperature, which may be about 80° C. The pH of the mixture may be modified or neutralized as desirable by the addition of suitable base, such as sodium carbonate.

In the first stage of this batch process, about 75 to 85% of the mass will be water-soluble polysaccharide (starch) and accordingly, polysaccharide radicals are formed preferentially over radicals formed on the ethylenically unsaturated monomers. These polysaccharide radicals become sites for grafting of ethylenically unsaturated monomers. The water soluble, hydrophilic ethylenically unsaturated monomers, as compared to the hydrophobic monomers, react preferentially with the polysaccharide radicals in the early stage of stage one ethylenically unsaturated polymerization. One associated function of the water soluble ethylenically unsaturated monomer is to prevent the polysaccharide radicals from living long enough to enter oxidation reactions that would destroy their ability to graft.

In time, the preference for chain growth based predominantly on reactivity with hydrophilic ethylenically unsaturated monomers, transitions to chain growth involving all the monomers. Since, in some embodiments, only up to about 10% of the ethylenically unsaturated monomers are hydrophilic, the growing chain will become largely hydrophobic. At this stage the molecule may enter micelles for nucleation, depending on the molecular fragment size, or may act as a nucleus that will gradually swell with monomer.

It is particularly useful to limit the graft length in order to improve the stability of the emulsion. Thus, a suitable amount of a chain transfer agent may be used, ensuring chain transfer to the polysaccharide backbone. Water soluble chain transfer agents are particularly useful. Use of chain transfer agents enhances the number of grafting positions created along the backbone and limits the formation of long graft chains. Suitable chain transfer agents may include carbon tetrachloride, bromoform, organic trithiocarbonates, organic dithiocarbonates, and organic xanthates, and mercaptans, such as alkyl or aralkyl mercaptans having about 2 to 20 carbons. Particularly useful chain transfer agents may include 2-mercaptoethanol and -n-dodecylmercaptan. Desirably, the chain transfer agent is employed in an amount from about 0.1 percent to about 0.6% by weight, preferably from about 0.1 to about 0.3% by weight based on reacted monomer weight. In some instances, ethylenically unsaturated monomers employed in the monomer mixture, such as vinyl acetate, can act as the chain transfer agent.

Preferably, stage one polymerization proceeds until sufficient time is allowed to have substantially all the first stage monomers depleted. In the second emulsion polymerization stage, an additional amount of an ethylenically unsaturated monomer mixture, which may be the same or different mixture than was used in stage one, may be fed into the reaction chamber with the reaction product of the first stage to generate the polymeric binder. Additional amounts of the chain transfer agent and other additives (surfactants) may be added.

In some embodiments, all or a portion of the chain transfer agent(s) and other additives may be blended into the first and/or second monomer mixture feeds. The second monomer mixture feed may be delivered over a period of one to three hours, though longer or shorter times may be employed.

In some embodiments, it will be useful to conduct the stage two polymerization in the same reaction chamber in which was conducted stage one polymerization. Stage two polymerization may be commenced after stage one polymerization with a rest period between stage one and stage two polymerization of at least about 10 to about 30 minutes.

A redox chase may be employed following stage two polymerization to substantially rid the emulsion product of excess monomer. Suitable oxidizers may include ammonium persulfate, cumene hydroperoxide, t-butyl hydroperoxide, hydrogen peroxide, potassium persulfate, and sodium persulfate. Suitable reducers may include sodium metabisulfite, sodium thiosulfate, sodium formaldehyde sulfoxylate, sodium hydrosulfite, sodium bisulfite, hydroxymethanesulfonic acid, iron (II) sulfate, formic acid, ammonium bisulfate, lactic acid, ascorbic acid, and isoascorbic acid.

The pH of the final emulsion may be adjusted to between about 6 and about 8.5.

In some embodiments of the invention, the first and second ethylenically unsaturated monomer mixtures may have substantially the same relative ratios of individual monomer species and/or substantially the same ratios of hydrophilic to hydrophobic ethylenically unsaturated monomers. As noted previously, the weight percent of hydrophilic monomers may be between about 1 and about 10%. Whether the monomer blend of the first and second ethylenically unsaturated monomer mixtures is the same or not, it is generally useful for at least the first of these monomer mixtures to comprise at least 1 weight percent of hydrophilic species.

For the entire two-stage emulsion polymerization process, the unmodified starch will preferably comprise between about 15 and about 25% by weight with respect to total monomer weight. Higher levels of starch incorporation may be possible. The remaining monomer weight may be supplied by the ethylenically unsaturated monomers. Of the latter, it is useful in some embodiments for 1 to about 50% of the ethylenically unsaturated monomers to be fed into the reaction chamber in the first polymerization stage, preferably about 5 to about 15%.

Reaction products from the two-stage emulsion polymerization embodiments outlined above may include polymeric binders comprising from about 30 to about 60% by weight, with respect to total polymer weight, derived from polysaccharide starting materials.

The above polymer can be used by itself as a sole binder, or in combination with a latex as a film forming resin in coating compositions. The polymer may also be useful in adhesive, caulk and sealant compositions.

Examples of latex compositions in which the polymer products of the present invention may be blended include, for example, those based on resins or binders of vinyl acrylic, styrene acrylic, all acrylic, copolymers of acrylonitrile wherein the comonomer may be a diene like isoprene, butadiene or chloroprene, homopolymers and copolymers of styrene, homopolymers and copolymers of vinyl halide resins such as vinyl chloride, vinylidene chloride or vinyl esters such as vinyl acetate, vinyl acetate homopolymers and copolymers, copolymers of styrene and unsaturated acid anhydrides like maleic anhydrides, homopolymers and copolymers of acrylic and methacrylic acid and their esters and derivatives, polybutadiene, polyisoprene, butyl rubber, natural rubber, ethylene-propylene copolymers, olefins resins like polyethylene and polypropylene, polyvinyl alcohol, carboxylated natural and synthetic latexes, polyurethane and urethane-acrylic hybrid dispersions, epoxies, epoxy esters and other similar polymeric latex materials. The ratio of the polymers of the present invention to the latexes in a coating composition covers a wide range depending on the desired properties of the final coating product and intended uses

The coatings of this invention may typically be applied to any substrate such as metal, plastic, wood, paper, ceramic, composites, dry wall, and glass, by brushing, dipping, roll coating, flow coating, spraying or other method conventionally employed in the coating industry.

Opacifying pigments that include white pigments such as titanium dioxide, zinc oxide, antimony oxide, etc. and organic or inorganic chromatic pigments such as iron oxide, carbon black, phthalocyanine blue, etc. may be used. The coatings may also contain extender pigments such as calcium carbonate, clay, silica, talc, etc.

The following examples have been selected to illustrate specific embodiments and practices of advantage to a more complete understanding of the invention.

### EXAMPLES

### Example 1

To evaluate the level of grafting of hydrophilic, ethylenically unsaturated monomers onto starch in the absence of a chain transfer agent, 701 g of starch (M.W. 46000) was dissolved in water heated at 70° C. in a five neck 5 L flask fitted with overhead stirrer, thermometer, nitrogen inlet, condenser and feeding port. A mixture of surfactants (47.4 g of Polystep B-23 and 18.9 g of Igepal CO-897) was added with 0.4 g of sodium carbonate. A redox initiator feed of sodium bisulfite and ammonium persulfate was started 6 minutes before the monomer-feed. Approximately 141 g of a monomer mixture comprising butyl acrylate 29% and vinyl acetate 38% was added. After a 15 minute hold the rest of the monomer feed (1272 g) and initiator feed (sodium bisulfite/ammonium persulfate) were added over a 4 hour period. Solutions of tert-butyl peroxide and sodium bisulfite were added at 70° C. during a one hour period. After an addition 30 minute hold, the batch was cooled, pH adjusted, and filtered. The starch content of the resultant polymer resin was approximately 0 weight %. Example 1 demonstrates that there was substantially no grafting onto the starch backbone in the absence of a chain transfer agent or hydrophilic, ethylenically unsaturated monomers. Importantly, a dry film of the resin exhibited poor scrub resistance after only 115 cycles under a binder/TiO2 Screen Test (24 Hr dry).

### Example 2

To evaluate the effect incorporating a non-water-soluble chain transfer agent would have on the grafting of hydrophobic, ethylenically unsaturated monomers onto a starch backbone, 733 g of starch (M.W. 46000) was dissolved in water heated at 70° C. in a five neck 5 L flask fitted with overhead stirrer, thermometer, nitrogen inlet, condenser and feeding port. The solution was purged with nitrogen for 10 minutes and, a mixture of surfactants (Polystep B-23 and Igepal CO-897) was added. The solution was heated to 80° C. An initial initiator charge of 0.42 g of sodium persulfate was added, followed by approximately 10% of a monomer mixture comprising 623 g of methyl methacrylate and 912 g of butyl acrylate. 46.73 g of an emulsifier (Igepal CO-897), 4.45 g of a water insoluble chain transfer agent (N-dodecylmercaptan) and 0.24 g of sodium carbonate were added in that order. After a 15 minutes hold, the remaining monomer mixture and a solution of 13.3 g of sodium persulfate and 1.98 g of sodium carbonate in 30 g water were concurrently fed into the reaction vessel via separate streams over a 2 hour time period. The temperature was lowered to 70° C. to feed 70%-tert-butyl hydroperoxide (2.2 g in 18 g of water), and ascorbic acid (3.3 g in 25 g water and 2.12 g 30% sodium hydroxide) for 1 hour. After an additional 1-hour hold, the batch was cooled. The pH was adjusted to about 8.5 by addition of sodium hydroxide. The starch content of the resultant polymer resin was approximately 6 weight %. It is believed that the lack of hydrophilic chain transfer agent and monomers resulted in starch backbones having very long acrylic chains, which imparted poor stability to the resin. The resulting resin gelled within 1 month.

### Example 3

To evaluate the effect incorporating a water-soluble chain transfer agent would have on the grafting of hydrophobic, ethylenically unsaturated monomers, 733 g of starch (M.W. 56000) was dissolved in water heated at 70° C. in a five neck 5 L flask fitted with overhead stirrer, thermometer, nitrogen inlet, condenser and feeding port. The solution was purged with nitrogen for 10 minutes and a mixture of surfactants (28 g of Polystep B-23 and 63 g of Igepal CO-897) was added. The solution was heated to 80° C. Then, the initial initiator charge (sodium persulfate, 0.42 g) followed by approximately 10% of a monomer mixture comprising 623 g of methyl methacrylate and 912 g of butyl acrylate. 46.73 g of an emulsifier (Igepal CO-897), 4.45 g of a water-soluble chain transfer agent (2-mercaptoethanol) and 0.54 g of sodium carbonate were added in that order. After a 15 minutes hold, the remaining monomer mixture and a solution of 4.45 g of sodium persulfate and 0.5 g of sodium carbonate in 38 g water were concurrently fed into the reaction vessel via separate streams over a 2 hour time period. The temp was lowered to 70° C. to feed 70%-tert-butyl hydroperoxide (2.2 g in 18 g of water), and ascorbic acid (3.3 g in 25 g water and 2.12 g 30% sodium hydroxide) for 1 hour. After an additional 1 hour hold, the batch was cooled. The starch content of the resultant polymer resin was approximately 15 weight %.

### Example 4

To evaluate the effect incorporating a water-soluble chain transfer agent would have on the grafting of hydrophobic, ethylenically unsaturated monomers onto hydrophobically modified starch, 701 g of a hydrophobically modified starch (starch octenyl succinate) was dispersed in water heated at 70° C. in a five neck 3 L flask fitted with overhead stirrer, thermometer, nitrogen inlet, condenser and feeding port. The solution was purged with nitrogen for 10 minutes and, a mixture of surfactants (11 g of Polystep B-23 and 4.3 g of Rhodasurf BC-840 4.3 g) was added. The solution was heated to 80° C. Then was added the initial initiator charge (sodium persulfate, 0.54 g) followed by 10% of a monomer mixture comprising 252 g of methyl methacrylate and 288 g of butyl acrylate. 4.3 g of Rhodasurf BC-840, 90 g of 2-ethylhexyl acrylate, 1.8 g of 2-mercaptoethanol, 0.3 g of 30% sodium hydroxide and 0.1 g of mercaptoethanol were added in that order. After a 15 minute hold the remaining monomer mixture and a solution of 1.8 g of sodium persulfate and sodium hydroxide (30%, 2.0 g in 39 g water) were concurrently fed into the reaction vessel via separate streams over a 2 hour time period. The temperature was lowered to 70° C. to feed 70%-tert-butyl hydroperoxide (0.9 g in 32 g of water), and a mixture of ascorbic acid (1.35 g) and 30% sodium hydroxide (0.89 g) in 23 g water) over 1 hour. After an addition 1 hour hold, the batch was cooled, pH adjusted, and filtered. The starch content of the resultant polymer resin was approximately 16 weight %.

### Example 5

To evaluate the effect incorporating a water-soluble chain transfer agent would have on the grafting of hydrophilic, ethylenically unsaturated monomers, 701 g of starch (M.W. 46000) was dissolved in water heated at 70° C. in a five neck 5 L flask fitted with overhead stirrer, thermometer, nitrogen inlet, condenser and feeding port. The solution was purged with nitrogen for 10 min. and, a mixture of surfactants (28 g of Polystep B-23 and 62 g of Igepal CO-897) was added. The solution was heated to 80° C. Then, was added the initial initiator charge (sodium persulfate, 0.42 g) followed by approximately 10% of a monomer mixture comprising 440 g of methyl methacrylate and 880 g of butyl acrylate. 46.2 g of an emulsifier (Igepal CO-897), 220 g of poly(propyleneglycol)methacrylate (Bisomer PPM 5HI), 4.45 g of a water-soluble chain transfer agent (2-mercaptoethanol) and 0.54 g of sodium carbonate and 0.27 g of mercaptoethanol were added in that order. After a 15 minute hold, the remaining monomer mixture and a solution of 4.45 g of sodium persulfate and 0.66 g of sodium carbonate in 39 g water were concurrently fed into the reaction vessel via separate streams over a 2 hour time period. The temperature was lowered to 70° C. to feed 70%-tert-butyl hydroperoxide (2.2 g in 28 g of water), and ascorbic acid (3.3 g in 28 g water) and 2.12 g of 30% sodium hydroxide for 1 hour. After an additional 1 hour hold, the batch was cooled. The pH was adjusted to about 8.07, and filtered. The starch content of the resultant polymer resin was approximately 23 weight %. Moreover, the resin remained stable 6 months later. Importantly, a dry film of the resin exhibited excellent scrub resistance through 2800 cycles under a binder/TiO2 Screen Test (24 Hr dry).

### Example 6

To evaluate the effect of using vinyl acetate as a hydrophilic monomer component and water soluble chain transfer agent on the grafting of hydrophobic, ethylenically unsaturated monomers onto a starch backbone, 488 g of starch (M.W. 46000) was dissolved in water heated at 70° C. in a five neck 5 L flask fitted with overhead stirrer, thermometer, nitrogen inlet, condenser and feeding port. The solution was purged with nitrogen for 3 minutes and a mixture of surfactants (Polystep B-23 and defoamer DEE215) was added. An initial initiator charge of 1.24 g of sodium persulfate was added, followed by approximately 10% of a monomer mixture comprising 697 g of vinyl acetate, 91.8 g of Veova 10 and 587 g of butyl acrylate. Next, 10 g of an emulsifier (Novel TDA 30/70) and 0.74 g of sodium carbonate were added to the charge in that order. After a 15 minutes hold, the remaining monomer mixture and a solution of 4.22 g of sodium persulfate in 92 g of water and a solution of 3.35 g of sodium bicarbonate in 2.75 g sodium metabisulfite in 50 g of water were concurrently fed into the reaction vessel via separate streams over a 4.5 hour time period. After holding for one hour at 70° C. solutions of 70%-tert-butyl hydroperoxide (1.84 in 34 g of water), and sodium metabisufite (2.75 g in 50 g water and 1.84 g 30% sodium hydroxide) for 1 hour. After an additional 0.5-hour hold, the batch was cooled. The pH was adjusted to about 4.75. The bound starch content of the resultant polymer resin was approximately 20 weight %.

The embodiments have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

We claim:

1. A film forming polymer prepared according to a process comprising the steps of:
a. preparing a hydrophobically modified polysaccharide as the emulsion reaction product of at least one water soluble polysaccharide and a first monomer mixture comprising hydrophilic ethylenically unsaturated monomer and hydrophobic ethylenically unsaturated monomer; and
b. reacting in a subsequent emulsion polymerization, the hydrophobically modified polysaccharide of step a) with a second monomer mixture comprising ethylenically unsaturated monomer.

2. The film forming polymer of claim 1, wherein step a) further includes, in the emulsion reaction, a water soluble chain transfer agent.

3. The film forming polymer of claim 2, wherein the water soluble chain transfer agent is selected from the group consisting of water soluble organic trithiocarbonates, organic dithiocarbonates, organic xanthates and mercaptans,

4. The film forming polymer of claim 2, wherein step a) the water soluble chain transfer agent is a hydrophilic ethylenically unsaturated monomer.

5. The film forming polymer of claim 4, wherein the water soluble chain transfer agent is vinyl acetate.

6. The film forming polymer of claim 1, wherein the polysaccharide is starch.

7. The film forming polymer of claim 6, wherein the starch has a molecular weight of between 1,000 and 80000.

8. The film forming polymer of claim 7, wherein the starch has a molecular weight of between 1,000 and 60000.

9. The film forming polymer of claim 8, wherein the water soluble starch is selected from the group consisting of dextrins and maltodextrins.

10. The film forming polymer of claim 6, wherein 15 to 30 percent of its weight is from the polysaccharide.

11. A film forming polymer prepared according to a process comprising the steps of:
a. reacting in a first emulsion polymerization stage a blend comprising:
i. water;
ii. a starch or starch derivative, which is at least 30 weight percent soluble in water;
iii. a first mixture of ethylenically unsaturated monomers, comprising hydrophilic and hydrophobic ethylenically unsaturated monomers;
iv. a water soluble chain transfer agent; and
v. a water soluble initiator.
b. reacting, in a second emulsion polymerization stage, the reaction product of step a) with a second monomer mixture comprising ethylenically unsaturated monomer.

12. The film forming polymer of claim 11, wherein the first mixture of ethylenically unsaturated monomers comprises from about 1 to about 10 by weight of hydrophilic ethylenically unsaturated monomers.

13. The film forming polymer of claim 11, wherein the first and second monomer mixtures comprise substantially the same monomers.

14. The film forming polymer of claim 11, wherein the water soluble chain transfer agent is a hydrophilic ethylenically unsaturated monomer.

15. The film forming polymer of claim 14, wherein the water soluble chain transfer agent is vinyl acetate.

16. The film forming polymer of claim 11, wherein at least 15% of its weight is from the starch or starch derivative.

17. A film forming polymer prepared as the emulsion polymerization reaction product of:
a. a hydrophobically modified starch selected from the group consisting of hydroxyalkyl starch and starch alkyl succinate; and
b. an ethylenically unsaturated monomer.

18. The film forming polymer of claim 17, wherein the hydroxyalkyl starch is hydroxypropyl starch.

19. The film forming polymer of claim 17, wherein the starch is starch octenyl succinate.
